(19) United States
(12) Patent Application Publication
(10) Pub. No.: US 2009/0027584 A1
(43) Pub. Date: Jan. 29, 2009

(54) LIQUID CRYSTAL DISPLAY WITH A BACKLIGHT ASSEMBLY HAVING AN IMPROVED STRUCTURE

(76) Inventors: Sang Sun Han, Cheonan-Si (KR); Yong Il Kim, Suwon-Si (KR)

Correspondence Address: F. CHAU & ASSOCIATES, LLC, 130 WOODBURY ROAD, WOODBURY, NY, 11797, US

(21) Appl. No.: 11/876,281

(22) Filed: Oct. 22, 2007

(30) Foreign Application Priority Data
Jul. 25, 2007 (KR) 10-2007-0074588

(51) Int. Cl. G02F 1/13357; F21S 4/00; G02F 1/13

(52) U.S. Cl. 349/58; 349/187; 349/61; 362/217; 362/225

(57) ABSTRACT

A liquid crystal display with improved backlight structure is presented. The liquid crystal display includes a liquid crystal (LC) panel for displaying image, a backlight assembly for providing light to the LC panel and a top frame combined with the bottom frame to complete LCD assembling. The backlight assembly includes a bottom frame, light source, and optical member. The bottom frame includes a light source receiving part, a side wall and a optical member receiving part which extends inwardly to the inner side of the backlight assembly. Thus, the overall size of the LCD can be reduced.

### CROSS-REFERENCE TO RELATED APPLICATION

This application claims priority to Korean Patent Application No. 2007-0074588, filed on Jul. 25, 2007 and all the benefits accruing therefrom under 35 U.S.C. §119, and the contents of which in its entirety are herein incorporated by reference.

### BACKGROUND OF THE INVENTION

1. Field of the Invention

The present invention relates to a liquid crystal display (LCD) with a backlight assembly, and more particularly, the present invention relates to a backlight assembly having a ‘U’ shaped edge of a bottom frame for compact exterior and light weight.

2. Description of the Related Art

As display devices are used in everyday life, the liquid crystal display (LCD) has been gaining popularity. The LCD has a liquid crystal (LC) panel which includes a pair of opposing substrates with a liquid crystal layer therebetween. The LCD also has a backlight assembly since the liquid crystal layer is not self-emissive. The backlight assembly is located behind the LC panel to provide light to the liquid crystal layer.

The backlight assembly is classified into two groups according to the location of a light source, a direct light backlight assembly and an edge light backlight assembly. In the direct light backlight assembly, the light source is located behind the LC panel with at least one optical member therebetween to enhance the illumination uniformity and/or viewing angle. The backlight assembly also needs a bottom frame which has a light source receiving part for accommodating light sources and a peripheral part outside of the light source receiving part.

The peripheral part has an overlap area with the optical member to securely support the optical member. Here, the overlap area extends to an opposite direction to the light source and makes the LCD bulky and heavy. Alternatively, an additional member for supporting the optical member may be used at the peripheral part of the backlight assembly. However, the additional supporting member increases the number of parts of the LCD, increases the weight and manufacturing cost of the LCD while still providing a bulky LCD.

### BRIEF SUMMARY OF THE INVENTION

Thus, it is an aspect of the present invention to provide an LCD with a backlight assembly having improved structure at the peripheral part for a compact exterior, less number of parts, less manufacturing cost, and lighter weight.

According to an embodiment of present invention, a backlight assembly of an LCD includes a light source, an optical member, and a bottom frame. The light source is located behind an LC panel to emit light to the LC panel. The optical member is at least one of a diffusing plate, a diffusing sheet and a light collimating sheet to control light distribution by changing light direction.

The bottom frame includes a light source receiving part and a peripheral part. The light source receiving part receives and overlaps with the light source while the peripheral part is located outside of the light source receiving part and supports the optical member which is separated from the light source for effectively controlling light distribution.

In detail, the bottom frame includes a side wall which is vertically elongated from the edge of the light source receiving part and an optical member supporting part which is bent and elongated to the light source direction. Here, the optical member supporting part may be parallel to the light source receiving part of the bottom frame.

According to another embodiment of the present invention, an LCD includes an LC panel, a middle frame, a top frame and a backlight assembly. The backlight assembly includes a light source, an optical member and a bottom frame which includes a light source receiving part and a peripheral part. The peripheral part is elongated from the light source receiving part and includes a side wall vertically extended from the light source receiving part and an optical member supporting part extended from the side wall to the light source receiving part.

The middle frame is located on the optical member supporting part and includes a gap former for maintaining space between the LC panel and optical member while supporting the LC panel at LC panel's bottom surface. The middle frame also includes a supporting part that extends from the gap former on the optical member supporting part of the bottom frame.

According to yet another embodiment of the present invention, a backlight assembly includes an empty space at a peripheral part by an opening to the light source direction. In addition, a top frame includes an LC panel supporting part for holding the LC panel by the upper edge of the LC panel and a side adjoining wall extending from the LC panel supporting part and overlapping the side wall of the bottom frame.

At the side adjoining wall, the adjoining structure may be formed for mechanical assembly of the bottom and top frames. The adjoining structure may be a screw hole for penetration of a screw to the empty space of the peripheral part of the bottom frame.

### BRIEF DESCRIPTION OF THE DRAWINGS

The above and/or other aspects and advantages of the present invention will become apparent and more readily appreciated from the following description of the exemplary embodiments, taken in conjunction with the accompanying drawings of which:

FIG. 1a is a cross-sectional view of a liquid crystal display (LCD) having a ‘U’ shaped peripheral part of a backlight assembly according to the present invention;

FIG. 1b is a cross-sectional view of a LCD having a peripheral part extending away from the light source which is different from the LCD of FIG. 1a according to the present invention;

FIG. 2 is an exploded view of a LCD having a ‘U’ shaped peripheral part of a backlight assembly according to one exemplary embodiment of the present invention;

FIG. 3 is a cross-sectional view of a backlight assembly where an edge of a lamp crosses a slant surface of a reflection sheet according to another exemplary embodiment of the present invention;

FIG. 4 is a cross-sectional view of a backlight assembly where a lamp does not meet to a slant surface of a reflection sheet according to yet another exemplary embodiment of the present invention;

FIG. 5 is a cross-sectional view of a backlight assembly where a plane light source is located in proximity to a bottom frame according to still another exemplary embodiment of the present invention;

FIG. 6 is a cross-sectional view of a LCD whose bottom frame and top frame are adjoined at a space made by the bottom frame and a reflection sheet according to yet another exemplary embodiment of the present invention;

FIG. 7a is a plan view of an LCD whose adjoining member conjoins a side wall of a bottom frame and a side adjoining wall of a top frame according to one exemplary embodiment of the present invention;

FIG. 7b is a plan view of an LCD whose adjoining member extends from a liquid crystal (LC) panel supporting part of a top frame to the thickness direction of the LCD for conjoining the top frame and a bottom frame;

FIG. 8 is a cross-sectional view of a LCD whose middle frame is fixed by a space between the side wall of the bottom frame and the side adjoining wall of the top frame according to another embodiment of the present invention.

### DETAILED DESCRIPTION OF THE INVENTION

Reference will now be made in detail to exemplary embodiments of the present invention, examples of which are illustrated in the accompanying drawings, wherein like reference numerals refer to like elements throughout. The embodiments are described below in order to explain the present invention by referring to the figures.

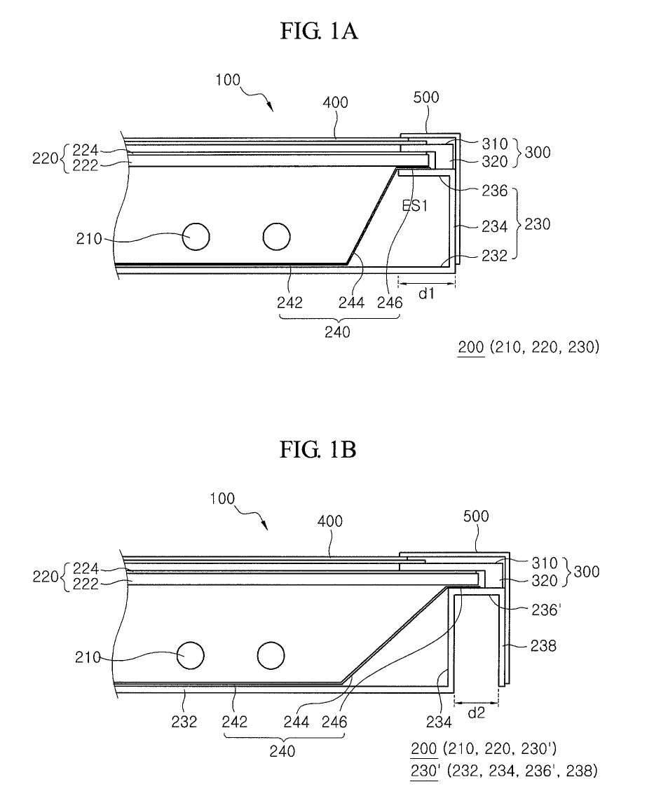

FIG. 1a is a cross-sectional view of a liquid crystal display (LCD) having a ‘U’ shaped peripheral part of a backlight assembly. Referring to FIG. 1a, an LCD 100 includes a backlight assembly 200, liquid crystal (LC) panel 400 and top frame 500. The LCD may include an additional middle frame 300. The backlight assembly 200 includes a light source 210, an optical member 220 and a bottom frame 230.

Here, the bottom frame 230 includes a light source receiving part 232 for accommodating the light source, a side wall 234 vertically located on the edge of the light source receiving part 232, and an optical member supporting part 236 horizontally extending from the side wall 234 to the light source 210.

Alternatively, the side wall 234 may not be vertical and the optical member supporting part may not be horizontal in the event another design rule is applied to the backlight assembly and LCD structure. However, within the spirit and scope of the invention, the similar shapes of vertical and horizontal structures are also applicable as long as the side wall 234 and the optical member supporting part 236 are bent in the same manner of FIG. 1a.

Consequently, because the optical member supporting part 236 is bent backwards toward the light source 210 and overlaps the light source receiving part 232 with a distance d1, the size of the LCD 100 can be reduced.

FIG. 1b is a cross-sectional view of a LCD having a peripheral part extending away from the light source which is different from the LCD of FIG. 1a. According to FIG. 1b, an optical member supporting part 236′ extends away from the side wall 234 by a distance d2 in a direction opposite to the light source 210. In comparison to FIG. 1a, the extra distance d2 causes size enlargement at one edge of the LCD 100. Furthermore, as the number of edges of LCD 100 increases the enlargement will be even more severe. That is to say, the LCD of FIG. 1b is bigger than the LCD of FIG. 1a by 2d2*2d2 when every edge has additional distance d2.

Even worse the peripheral part illustrated in FIG. 1b lies in the complexity of the structure in the bottom frame 230′. The bottom frame 230′ of FIG. 1b has additional side wall 238 since the bottom frame 230′ needs to be combined with the top frame 500 at the side edge. The additional side wall 238 extends from the outwardly extending optical member supporting part 236′ in a vertical direction. As a result, the structure of the bottom frame 230′ becomes more complex; thus, manufacturing cost, weight and size of the bottom frame will be increased opposed to the bottom frame 230 of FIG. 1a.

Now, referring to FIG. 1a again, the backlight assembly 200 includes a light source 210 behind the LC panel 400. The light source 210 may be one of Cold Cathode Fluorescent Lamp (CCFL), Hot Cathode Fluorescent Lamp (HCFL), Flat Fluorescent Lamp (FFL), Field Emission Lamp (FEL) and Light Emitting Diode (LED). The optical member 220 is located at the intervening space of the light source 210 and LC panel 400 for controlling light distribution. In the direct lighting backlight assembly of the present invention, a light diffusing plate 222 with a substantial thickness is placed at the lowest position among the optical members 220 to avoid drooping by gravity.

In addition, FIG. 1a includes reflection sheet 240 under the light source 210 and on the light source receiving part 232 of the bottom frame 230. Specifically, the reflective sheet 240 includes a light source reflection part 242 which contains an underneath portion of the light source and its neighboring portion, a slant reflection part 244 which connects the light source reflection part, and the optical member supporting part 236 of the bottom frame 230.

The reflection sheet 240 also includes fixing part 246 on the optical member supporting part 236 of the bottom frame 230. The fixing part 246 may be interposed between the diffusing plate 222 and the optical member supporting part 236 and fixed by the pressure of the diffusing plate 222 and/or middle frame 300.

By fixing the reflection sheet 240 to the bottom frame, an empty space ES1 can be made. Namely, the light source receiving part 232, the side wall 234, the optical member supporting part 236 and the slant reflection part 244 form a space ES1 which can be used for combining the bottom frame 230 and the top frame 500 at the lateral side.

In connection with the empty space of FIG. 1a, even though a closed space is explained, the space may be an open space as long as the optical member supporting part 236 is bent backwards toward the light source 210 and the space is used for combining the bottom frame 230 and the top frame 500.

In FIG. 1a, a middle frame 300 includes a gap former 310 disposed in the space between the LC panel 400 and the optical member 220. In addition, the middle frame 300 includes a supporting part 320 that extends from the gap former 310 on the optical member supporting part 236 of the bottom frame 230. The supporting part 320 may also define a distance from the bottom frame 230 to LC panel 400.

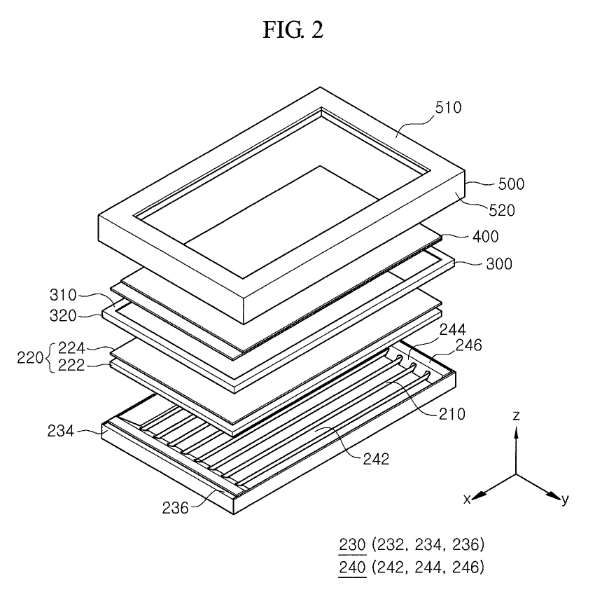

FIG. 2 is an exploded view of a LCD having a ‘U’ shaped peripheral part of a backlight assembly. Referring to FIG. 2, the LCD 100 includes the bottom frame 230, a light source 210, an optical sheet 220, a middle frame 300, a LC panel 400 and a top frame 500. The bottom frame 230 includes light source receiving part 232, a side wall 234 and optical member supporting part 236. As shown in FIG. 1a, the optical member supporting part 236 is bent toward the light source 210 to form a ‘U’ shape and overlap the optical member 220, middle frame 300 and top frame 500.

Although in FIG. 2, the optical member supporting part 236 is formed in the direction of the light source, namely X direction, the optical member supporting part 236 can extend in the perpendicular direction of the light source, namely Y direction.

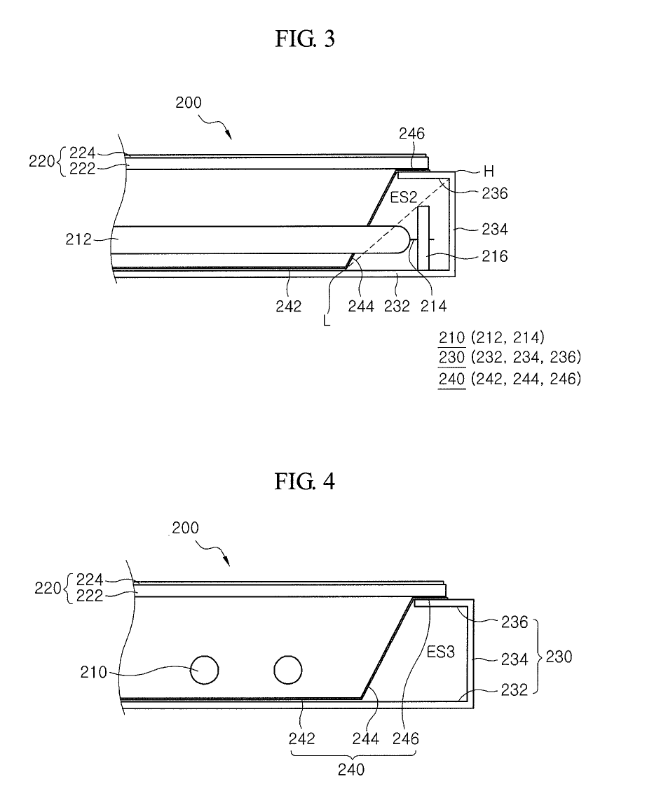

The refection sheet 240 includes the light source reflection part 242, the slant reflection part 244 and a fixing part 246. The fixing part 246 is fixed by the pressure of the diffusing plate 222 and the middle frame 300. As shown in FIG. 2, an edge portion of the light source 210 passes an opening of the slant reflection part 244 of the reflection sheet 240; the details of the penetrating structure will be explained later in relation to FIG. 3. Alternatively, the slant reflection part 244 can be formed without contacting the lamp 210 and the detailed structure will be introduced later in relation to FIG. 4.

Now, the assembling step of the LCD 100 is explained hereinafter. An electricity providing part (not shown) is formed in the bottom frame 230 for driving the lamp 210. The bottom frame 230 is ready after the reflection sheet 240 is adhered to the inner side of the bottom frame 230 and the lamps 210 are installed in the light source receiving part 232 of the bottom frame 230.

Then, the diffusing plate 222 and other optical members 220 are disposed on or above the optical member supporting part 236 of the bottom frame. For secure support, more than half of the optical member supporting part 236 is used for overlap relationship to optical member 220.

Next, middle frame 300 is disposed on the optical member supporting part 236, especially on the outer side of the optical member supporting part 236. The middle frame 300 may have a closed rectangular shape as shown in FIG. 2. Otherwise, the middle frame 300 may be separated and disposed independently on the bottom frame 230. Here, each of the middle frames 300 may be closely located without space therebetween or spaced apart with a certain distance. The separated middle frame is helpful for easy assembly of the LCD, especially in a large LCD. A 52 inch diagonal LCD is a good example for adopting the separated middle frames.

The middle frame 300 includes the gap former 210 for making space between the LC panel 400 and optical member 220 while the gap former 310 sustains the low surface of the LC panel 400. The middle frame 300 also includes the supporting part 320 which is attached to the gap former 310 and extends to the optical member supporting part 236; the supporting part 320 is used for defining distance from the bottom frame 230 and the LC panel 400.

After the LC panel is disposed on the gap former 310 of the middle frame 300, assembling of the LCD 100 is completed by pressing the LC panel 400 with the top frame 500 by the upper surface of the LC panel 400. Here, the top frame 500 includes an LC panel fixing part 510 which is substantially parallel to the LC panel 400 and side adjoining wall 520 which extends from the LC panel fixing part 510. The side adjoining wall 520 overlaps the side wall 234 of the bottom frame 230 with an overlapping area where an adjoining member is formed. The details of the adjoining member will be explained later in relation with FIG. 6.

FIG. 3 is a cross-sectional view of a backlight assembly where an edge of a lamp crosses a slant surface of a reflection sheet of FIG. 2. Referring to FIG. 3, the backlight assembly 200 includes an empty space ES2 surrounded by the light source receiving part 232, the side wall 234, the optical member supporting part 236 and the slanted reflection sheet 244.

The light source 210 includes a glass area 212 where light is outputted and a lead area 214 where a lead protrudes from glass. Then, the lead of the lead area 214 is fixed by a power supplying part 216 which is attached to the bottom frame 230. More specifically, the power supplying part 216 is located under the optical member supporting part 236 which extends backwards towards the light source 210 from the side wall 236; hence, the overall size of the LCD can be reduced.

In contrast, if the optical member supporting part 236 extends outwards from the side wall 234, the outer dimension of the LCD increases. With the outwardly extending structure of the optical member supporting part 236, even the thickness of the LCD would be increased. In detail, because the side wall 234 is located outside the power supplying part 216, the slant angel of the slant reflection sheet 244 becomes smaller by connecting the point L of a lower side of the slanted reflection sheet and the point H of an upper side of the side wall.

In FIG. 3, the connected line of L and H is depicted as a dotted line. As shown, the dotted line contacts the power supplying part 216 which is an unwanted structure of a backlight assembly. Thus, to avoid the contact of the slanted reflection sheet 244 and the power supplying part 216, the side wall's upper point H should move to a higher point. As a result the overall thickness of the LCD increases. Moreover and again, the plane area of the LCD also increases because the optical member supporting part extends outwardly from the side wall 234.

In conclusion, the overall size including the thickness and plane size of the LCD can be reduced by placing the optical member supporting part 236 inwardly from the side wall 234.

FIG. 4 is a cross-sectional view of a backlight assembly where a lamp does not meet the slant surface of the reflection sheet of FIG. 2. According to FIG. 4, the backlight assembly 200 includes an empty space ES3 surrounded by the light source receiving part 232, the side wall 234, the optical member supporting part 236 and the slanted reflection sheet 244.

Here, supposing the optical member supporting part 236 is missing from the backlight assembly 200, additional parts for supporting the optical member in proximity to the side wall 234 is needed. Therefore, the unified optical member supporting part to the bottom frame can accommodate the reduction of parts, weight and manufacturing cost of the LCD.

Further, inwardly extended optical member supporting parts of FIG. 4 can save space in the LCD exterior when compared to the additional member located outside of the side wall.

In conclusion, the overall size of the LCD can be reduced by placing the optical member supporting part 236 inwardly from the side wall 234.

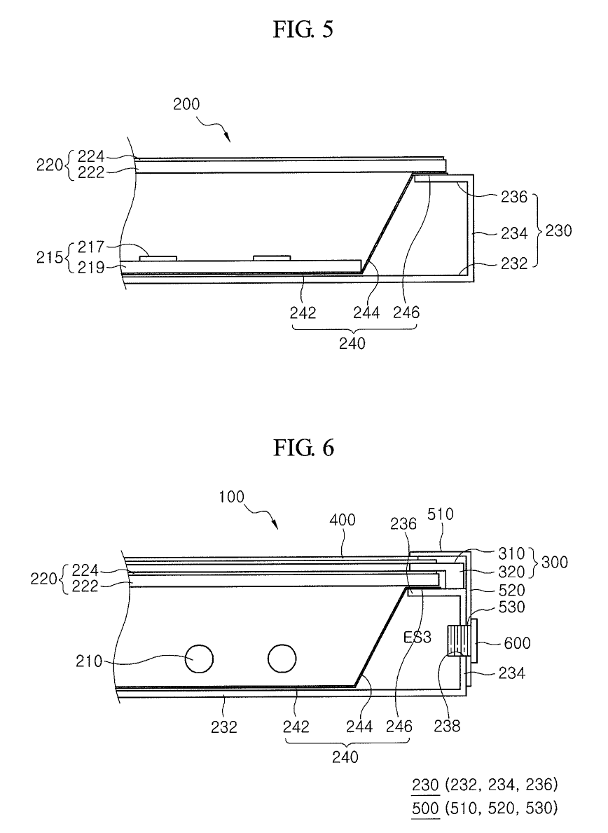

FIG. 5 is a cross-sectional view of a backlight assembly where a plane light source is located in proximity to a bottom frame. Referring to FIG. 5, the backlight assembly 200 accommodates a light source 215 received by a bottom frame 230. Unlike the light source of FIG. 3 and FIG. 4, the light source 215 has a plane shape and adheres to the bottom frame 230.

Here, the plane light source 215 may cover the whole light source receiving part 232 of the bottom frame 230 as a unitary part. Otherwise, the plane light source 215 is divided into several parts and located at the light source receiving part 232 while the plane light sources 215 are either spaced apart from each other or stick to each other. When each of the plane light sources 215 is spaced apart, a reflection sheet may be located at the interval.

The plane light source 215 may be one of FFL, FEL or a LED plane light source. In FIG. 5, a LED plane light source is introduced as an example. In detail, the plane light source 215 includes a substrate 217 and an individual LED 219 as a point light source attached on the substrate 217.

On or in the substrate 217, electrical wirings may be embedded for driving each LED 219. Additionally, the substrate 217 may include a reflection surface for reflecting and recycling of the light from the LEDs 219. Adopting a reflection surface to the substrate of the backlight assembly, the reflection sheet may not include light source reflection part 242, but still includes slant reflection part 244 and fixing part 246. Still further, the whole reflection sheet 240 can be omitted as long as uniformity and sufficient luminance can be provided to the LC panel with the plane light source 215.

Referring to FIG. 5, the bottom frame 230 includes a light source receiving part 232, a side wall 234 and optical member supporting part 236. On the light source receiving part 232, the plane light source 215 is adhered. Here, an additional reflection sheet (not shown) can be interposed between the plane light source and the light source receiving part for enhancing reflectivity.

Alternatively, the plane light source 215 may not be adhered to the light source receiving part 232 of the bottom frame 230 but instead maintain a certain amount of space (not shown) for enhancing light reflectivity, light distribution or thermal dissipation. Here, the inwardly protruded or expended optical member supporting part can reduce the overall out-dimension of the backlight assembly and the LCD.

Considering yet another alteration of FIG. 5, the plane light source 215 may be extended to the area under the optical member supporting part. Here, the extra area under the optical member 236 may be used for making uniform light distribution of the backlight assembly or fixing the plane light source 215 to the bottom frame 230. The configuration above may contribute to a more simplified structure or manufacturing process of the LCD.

FIG. 6 is a cross-sectional view of a LCD whose bottom frame and top frame are adjoined at a space made by the bottom frame and a reflection sheet. Referring to FIG. 6, a first penetration hole 238 is formed on the side wall 234 of the bottom frame 230; a second penetration hole 530 is formed on the side adjoining wall 520 of the top frame 500. The first and second penetration holes 238, 530 is located at the overlap area between the side wall 234 and side adjoining wall 520 and arranged side by side to each other for receiving adjoining member 600 at the same time.

In FIG. 6, a screw is introduced as an example of the adjoining member 600. The screw is fixed at the first and second penetration hole 238, 530 while the edge of the screw extrudes to the empty space ES3 defined by the bottom frame 230 and reflection sheet 240. As shown in FIG. 6, the empty space ES3 provides space for adjoining member's protrusion; however, the actual size of the LCD 100 is not enlarged during adjoining the bottom frame 230 and top frame 500, or at most the thickness of the screw is added to the total size of the LCD.

Here, the size maintained is apparent by comparison with conventional adjoining structures as below. In conventional structures, the bottom frame 230 and top frame 500 is adjoined by an adjoining member that extends down from the LC panel supporting part 510 of the top frame 500 to the optical member supporting part 236 or the bottom frame 230.

Considering a top-down adjoining structure, the width of the optical member supporting part 236 should be wide enough to encompass the widest part of the adjoining member 600. Supposing that the screw of FIG. 6 is used for the top-down adjoining structure, the head of the screw 610 should be encompassed by the LC panel supporting part 510 and optical member supporting part 236. Thus, the width of both the LC panel supporting part 510 and the optical member supporting part 236 should be enlarged. Here, the optical member supporting part 236 may extend outwardly from the light source 210 for securing an area for the adjoining member 600. Then, the overall size of the LCD is accordingly increased.

As a result, the inwardly positioned structure of the optical member supporting part in conjunction with the side adjoining structure of the top and bottom frame can contribute to make the exterior of the LCD compact.

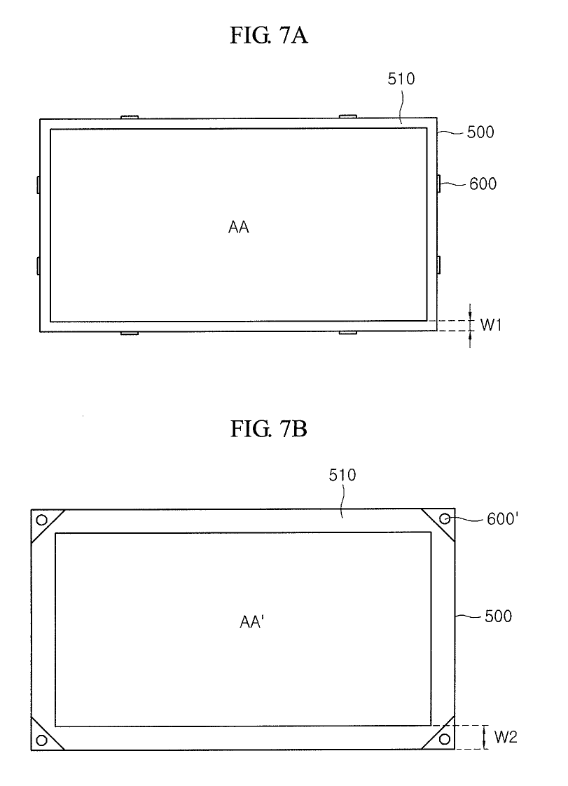

FIG. 7a is a plan view of an LCD whose adjoining member conjoins a side wall of a bottom frame and a side adjoining wall of a top frame as explained in FIG. 6. FIG. 7b is a plan view of an LCD whose adjoining member extends from a LC panel supporting part of a top frame to the thickest direction of the LCD for conjoining the top frame and a bottom frame.

Referring to FIGS. 7a and 7b, the LCD 100 includes the LC panel supporting part 510 of the top frame 500 around the active display area AA, AA′. In FIG. 7a, the optical member supporting part of the bottom frame (not shown) extends inwardly to the active display area AA as shown in FIG. 6.

There, the adjoining member 600 is inserted to the top frame 500 by the side adjoining wall; hence, extra width of the LC panel supporting part 510 of the top frame 500 for adjoining with the bottom frame is not needed. For example, the 52 inch diagonal LCD's LC panel supporting part has a width W1 of 13 mm according to FIG. 7a.

In contrast, the optical member supporting part of FIG. 7b extends outwardly from the active display area AA′. Here, the adjoining member is inserted down to the top frame 500 by the top portion of the top frame 500. In other words, the LC panel supporting part 510 receives the adjoining member 600 by an extra space for conjoining with the bottom frame. Thus, the size of the LCD is increased.

The increment is shown in FIG. 7b. In FIG. 7b, the LCD has a 52 inch diagonal length, and thus, has the same active display area AA′ with the active display area of FIG. 7a AA. However, the LC panel supporting part 510 is wider by having a width of 30 mm and 28.6 mm, respectively. More specifically, the adjoining member 600′ is located at the corner of the LCD since the corner portion does not have other parts that block the simple adjoining.

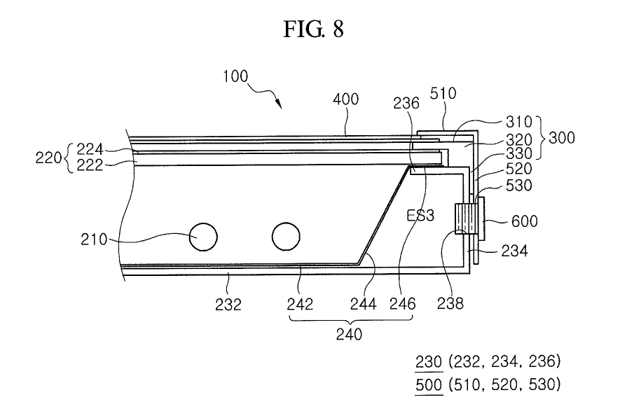

FIG. 8 is a cross-sectional view of a LCD whose middle frame is fixed by a space between the side wall of the bottom frame and the side adjoining wall of the top frame. Referring to FIG. 8, the middle frame 300 further includes an intervening part 330 that is positioned in between the side wall 234 of the bottom frame 230 and side adjoining wall 520 of the top frame 500. The intervening part 330 can be unified with the supporting part 320. Otherwise, the intervening part 330 can be attached to the supporting part 320 as a separate member.

The intervening part 330 is fixed when the adjoining member 600 is inserted and passes the first and second penetration holes 530, 238 of the top and bottom frame 500, 230. More specifically, as the side wall 236 and side adjoining wall 520 approach each other, the intervening member 300 is pressed at opposing sides and is fixed firmly.

Since the intervening part is unified with the supporting part 320 of the middle frame 300, the whole middle frame 300 is then settled securely. Thereafter, the optical member 220 and LC panel is prevented from movement when sudden impact is given to the LCD. Also, the unified structure of the middle frame may not need additional parts for fixing the middle frame to either the bottom frame or the top frame; hence, the number of parts and manufacturing steps may be reduced. Here, the intervening structure is not limited to FIG. 8, but may include any structure that is fixed while the bottom and top frame approach each other.

In the above embodiments, the optical member supporting part is explained as the place where the optical member is positioned. However, if the optical member is missing from the whole LCD or the optical member is positioned at another part, the optical member supporting part can support the LC panel directly.

Namely, once the bottom frame includes a light source receiving part, a side wall and a supporting surface extended from the side wall toward the light source, the supporting surface may be used for supporting any of an optical member or an LC panel as long as the whole LCD has a compact exterior.

The bottom frame in the embodiments above may be made of metal such as stainless steel. The metal bottom frame effectively dissipates heat from the light source. Also, the metal bottom frame can be used as a ground in an electrical manner and show high resistance to external impact.

On the other hand, the bottom frame can be made from electrically conductive plastic as long as resistance to impact and heat dissipation characteristics are satisfactory. The conductive plastic is proper for easily forming the side wall and optical member supporting part of the bottom frame since plastic is generally suitable for forming.

In other aspects, the top frame may be made from either metal or conductive plastic to make a secure structure by being combined with the bottom frame.

The optical member can be any type of diffusing sheet, prism sheet, transmissive and reflective sheet, or diffusing plate as long as light distribution and direction is changed by the optical member. The light source may be one of the Cold Cathode Fluorescent Lamp (CCFL), External Electrode Fluorescent Lamp (EEFL), Light Emitting Diode (LED) or LED plate, Field Emission Lamp (FEL) and Flat Fluorescent Lamp (FFL).

The adjoining member may be any structure that combines the top frame and bottom frame. For example, the combination of a protrusion and hole or screw is proper for the adjoining member. The slant reflection part may be substituted by an additional part as long as the additional part accommodates the forming of an empty space and reflection by being slanted from the light source receiving part to the optical member supporting part.

The above-described embodiments of the present invention are merely meant to be illustrative and not limiting. It will thus be obvious to those skilled in the art that various changes and modifications may be made without departing from this invention in its broader aspects. Therefore, the appended claims encompass all such changes and modifications as fall within the true spirit and scope of this invention.

What is claimed is:

1. A backlight assembly, comprising:
a light source;
an optical member disposed over the light source; and
a bottom frame accommodating the light source and the optical member, wherein the bottom frame comprises a first part facing the light source, a second part vertically extended from the first part, and a third part extending inwardly from the second part to the light source and supporting the optical member.

2. The backlight assembly of claim 1, further comprising a slant reflection part that connects the first part and the third part to reflect the light from the light source.

3. The backlight assembly of claim 2, wherein the first part, second part, third part and the slant reflection part form a first space in cross-sectional view.

4. The backlight assembly of claim 3, further comprising a power supplying part, wherein the light source comprises a light emitting part and electrode part for receiving power from the power supplying part, wherein the power supplying part is connected to the electrode part and located inside of the first space.

5. The backlight assembly of claim 4, wherein the power supplying part is spaced apart from the slant reflection part.

6. The backlight assembly of claim 4, wherein the first space is elongated along a first direction, wherein the first direction is parallel to the light source.

7. The backlight assembly of claim 1, wherein the light source is located in proximity to the first part of the bottom frame.

8. The backlight assembly of claim 7, wherein the light source is plane and adhered to the first part of the bottom frame.

9. The backlight assembly of claim 6, wherein the light source comprises a plurality of light emitting diodes (LEDs) on a first board.

10. The backlight assembly of claim 1, wherein the third part is overlapped with the optical member by at least 50 percent in width.

11. A liquid crystal display (LCD), comprising:
a light source;
a liquid crystal (LC) panel having liquid crystal layer, the LC panel disposed over the light source;
an optical member receiving light from the light source, the optical member emitting light to the LC panel;
a bottom frame accommodating the light source, wherein the bottom frame comprises a light source receiving part, a side wall vertically extended from the light source receiving part, and an optical member supporting part extending inwardly toward the light source from the side wall;
a top frame comprising a LC panel holding part and side adjoining wall that overlaps the side wall of the bottom frame; and
an adjoining member combining the bottom frame and the top frame.

12. The LCD of claim 11, wherein the adjoining member penetrates the side wall of the bottom frame and the side adjoining wall of the top frame.

13. The LCD of claim 11, further comprising a middle frame positioned between the top frame and the bottom frame, wherein the middle frame comprises a gap former which maintain a gap between the optical member and the LC panel and a supporting column positioned on the optical member supporting part.

14. The LCD of claim 13, wherein the optical member supporting part has a first overlap area overlapping the optical member and a second overlap area overlapping the supporting member of the middle frame, wherein the fist overlap area is larger than the second overlap area.

15. The LCD of claim 13, wherein the middle frame further comprising a intervening part positioned between the side wall of the bottom frame and the side adjoining wall of the top frame.

16. A liquid crystal display (LCD), comprising:
a liquid crystal (LC) panel for displaying image;
a light source positioned behind the LC panel; and
a light source containing member behind the light source, the light source containing member comprises a first surface substantially parallel to the LC panel, a second surface bent from the first surface to the LC panel direction, and a third surface bent from the second surface toward the light source direction, wherein the third surface at least partially overlaps the LC panel.

17. The LCD of claim 16, the light source is flat and located in close proximity to the first surface.

18. The LCD of claim 17, the light source comprises a board and a plurality of light emitting diodes (LEDs) attached to the board.

19. A method for making a liquid crystal display (LCD), the method comprising:
providing a light source;
facing the light source by placing a bottom frame behind the light source, wherein the bottom frame comprises a first surface facing the light source, a second surface vertically connected to the first surface, and a third surface extending inward and being parallel with the first surface from the second surface;
disposing an optical member on the third surface of the bottom frame, wherein the optical member redirects the light incident to the optical member;
covering the optical member with a liquid crystal (LC) panel; and
adjoining the bottom frame with a top frame, the top frame comprises an LC holding part and side adjoining wall.

20. The method of claim 19, wherein the adjoining of the bottom frame and the top frame is accomplished by a screw that penetrates the side wall of the bottom frame and the side adjoining wall of the top frame.
